(19) United States
(12) Patent Application Publication
(10) Pub. No.: US 2009/0201256 A1
(43) Pub. Date: Aug. 13, 2009

(54) PORTABLE TERMINAL HAVING INPUTTING MEANS USING IMAGE SENSOR

(75) Inventors: Jong-Sik Jeong, Seoul (KR); Byoung-ok Lee, Gyeonggi-do (KR)

Correspondence Address: BIRCH STEWART KOLASCH & BIRCH, PO BOX 747, FALLS CHURCH, VA, 22040-0747, US

(73) Assignee: MTEKVISION CO., LTD., Seoul (KR)

(21) Appl. No.: 11/577,685

(22) PCT Filed: Oct. 14, 2005
(86) PCT No.: PCT/KR2005/003449

§ 371 Date: Apr. 20, 2007

(30) Foreign Application Priority Data
Oct. 22, 2004 (KR) 1020040084743

(51) Int. Cl. G06F 3/041

(52) U.S. Cl. 345/173

(57) ABSTRACT

The present invention is directed to a portable terminal having inputting means using an image sensor and its input method. The portable terminal according to an embodiment of the present invention comprises a transparent solid plate mounted in a keypad area; an image sensor having unit cells of lattice type outputting an electrical signal corresponding to the light irradiated through the transparent solid plate; and a key selection recognizer generating and outputting a key button selection signal corresponding to the location of a unit cell that outputted the least electrical signal value by making reference to the size of the value of the electrical signal inputted from the unit cells. The present invention enables compacting of portable terminals owing to eliminating the need to design key buttons to match the size of human fingers.

### TECHNICAL FIELD

The present invention is directed to a portable terminal, more specifically to a portable terminal having inputting means using an image sensor and its input method.

### BACKGROUND ART

Recently, a variety of communication terminals, such as mobile communication terminals, personal digital assistants, and notebook computers, have been developed. These communication terminals allow a user to utilize the device while in transit, and hence are becoming smaller for better portability. It is typical that the exterior of communication terminals consists of a display with an LCD, a key input with a plurality of key buttons, and an interface for linking with an external device. Among these components, the display is getting bigger in order to show more information more realistically. Considering that communication terminals are becoming smaller, it is necessary to reduce the size of the key input, or restructure the display and key input as in sliding phones.

The structure of the key input of a portable terminal is as follows: Portable terminals are equipped with an area of key input, such as keyboard or keypad, to allow a user to input commands into the terminal. Arranged with a certain pattern within the key input are function keys and alphanumeric keys. For instance, the key input of a mobile communication terminal has function keys for accessing the Internet wirelessly, another function keys for connecting and disconnecting a phone call, and alphanumeric keys for inputting numbers and letters, arranged in the upper, middle, and lower part, respectively.

The size of key buttons arranged in the key input of a portable terminal is designed to accommodate the finger size of the user, and pressing a key button depresses the key itself to turn on the electrical switch connected to the key button.

This structure causes a problem of inadvertently pressing a wrong key button, for example an adjacent button, if a compact design of the portable terminal were desired by shrinking the size of key buttons below a certain level.

Moreover, the difficulty of designing the key button size below a certain level, in effect, becomes a hindrance to compacting the size of portable terminals below a certain level.

### DISCLOSURE

### Technical Problems

In order to solve aforementioned problem, the present invention aims to provide a portable terminal having inputting means using an image sensor and its input method that enable compacting of portable terminals owing to eliminating the need to design key buttons to match the size of human fingers by realizing the key input of a portable terminal using an image sensor.

Another objective of this invention is to provide a portable terminal having inputting means using an image sensor and its input method that enable a correct operation corresponding to the intended key stroke despite the erroneous recognition by the terminal that a multiple number of key buttons are simultaneously pressed due to compact-sized key buttons.

Another objective of the present invention is to provide a portable terminal having inputting means using an image sensor and its input method that can solve the problem of key button malfunctions due to a variety of causes (e.g., foreign objects inserted between key buttons) from extended use of the portable terminal.

### Technical Solution

In order to achieve aforementioned objectives, an aspect of the present invention provides a portable terminal comprising a transparent solid plate mounted in a keypad area; an image sensor having unit cells of lattice type outputting an electrical signal corresponding to the light irradiated through the transparent solid plate; and a key selection recognizer generating and outputting a key button selection signal corresponding to the location of a unit cell that outputted the least electrical signal value by making reference to the size of the value of the electrical signal inputted from the unit cells.

A keypad image, on which a plurality of key buttons are arranged, is printed on one side of the transparent solid plate; or a transparent sticker, on which the keypad image is printed, is adhered to one side of the transparent solid plate; and each key button included in the keypad image is corresponded to at least one unit cell.

The portable terminal can further comprise an A/D converter converting an analog electrical signal outputted from the unit cell to a digital electrical signal and delivering to the key selection recognizer.

The image sensor of the portable terminal comprises a control switch for turning each unit cell on/off individually, and the control switch is controlled by the key selection recognizer.

The key selection recognizer determines if the value of the minimum electrical signal is smaller than a predetermined critical value and generates the key button selection signal only if the value of the minimum electrical signal is smaller than the critical value.

Another aspect of the present invention provides a recording medium recording a program organizing commands that are executable by a portable terminal (here, the portable terminal has a transparent solid plate in a keypad area and comprises an image sensor having unit cells of lattice type outputting an electrical signal corresponding to the light irradiated through the transparent solid plate, and a keypad image, on which a plurality of key buttons are arranged, is printed on one side of the transparent solid plate, or a transparent sticker, on which the keypad image is printed, is adhered to one side of the transparent solid plate, and each key button included in the keypad image is corresponded to at least one unit cell), for executing a method for recognizing a key button selected by a user, comprising the acts of receiving an input of electrical signal from at least one unit cell; determining whether the value of the electrical signal became smaller than the value of the immediately previous inputted electrical signal; recognizing, if it became smaller, a key button corresponding to a unit cell that outputted the electrical signal; and generating and outputting a key button selection signal corresponding to the recognized key button.

The program further receives an electrical signal input outputted by activating a unit cell of the latter sequence if the value of the electrical signal did not become smaller than the value of the immediately previous inputted electrical signal.

The steps of recognizing a key button corresponding to a unit cell that outputted the electrical signal comprise determining whether the value of the electrical signal is smaller than a predetermined critical value, if the value of the electrical signal became smaller than the value of the immediately previous inputted electrical signal; and recognizing, if it is smaller than a predetermined critical value, a key button corresponding to the location of a unit cell that outputted the electrical signal.

### DESCRIPTION OF DRAWINGS

These and other features, aspects, and advantages of the present invention will become better understood with regard to the following description, appended claims, and accompanying drawings where:

FIG. 1 shows a block diagram of a portable terminal having a key input using an image sensor, based on a preferred embodiment of the present invention;

FIG. 2 shows an illustration of a key input based on a preferred embodiment of the present invention;

FIG. 3 shows a flowchart of the method for recognizing a key button by the key selection recognizer, based on a preferred embodiment of the present invention;

FIG. 4 shows a graph illustrating the change in output signal value, based on a preferred embodiment of the present invention;

FIG. 5 shows a flowchart of the method for recognizing a key button by the key selection recognizer, based on another embodiment of the present invention; and

FIG. 6 shows a flowchart of the method for recognizing a key button by the key selection recognizer, based on yet another preferred embodiment of the present invention.

100: Portable terminal
110: Key input
115: Display
120: Communication unit
125: Sound outputting unit
130: Control unit
140: Image sensor
145: A/D converter
150: Key selection recognizer

### MODE FOR INVENTION

The present invention, operative advantages of the present invention, and objectives achieved by embodying the present invention shall be apparent with reference to the accompanying drawings and the description therein.

Hereinafter, preferred embodiments of the present invention shall be described in detail with reference to the accompanying drawings. To aid overall understanding of the present invention, the same reference numbers shall be assigned to the same means, regardless of the figure number.

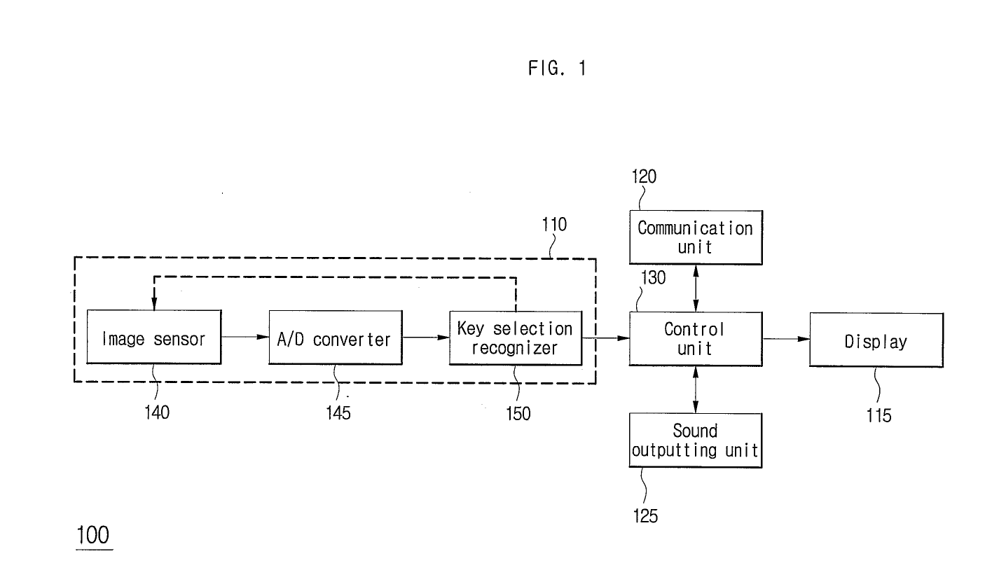

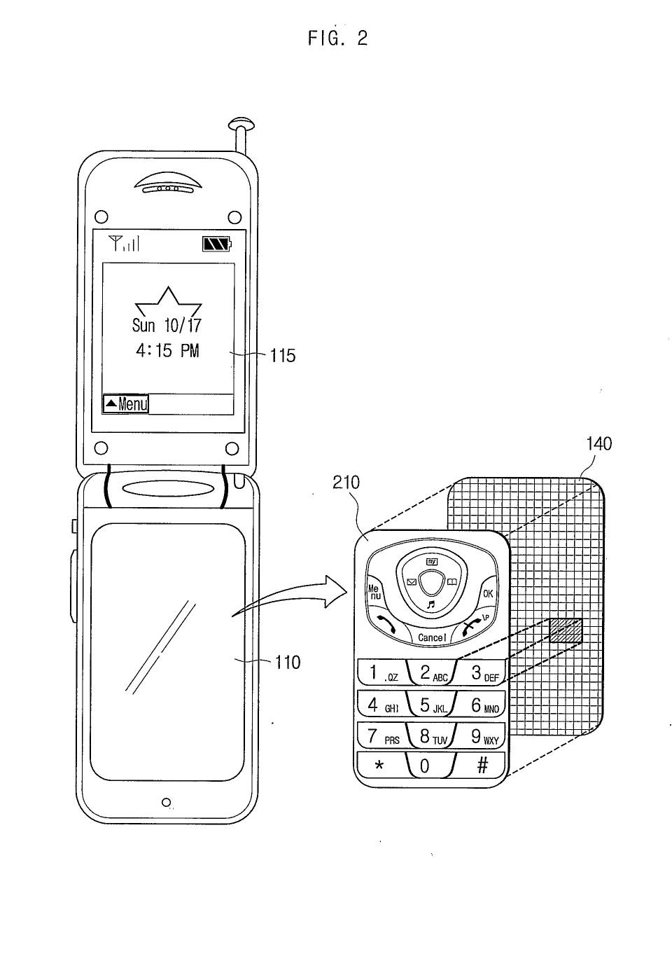

FIG. 1 is a block diagram of a portable terminal having a key input using an image sensor, based on a preferred embodiment of this invention. FIG. 2 is an illustration of a key input based on a preferred embodiment of this invention.

Referring to FIG. 1, a portable terminal 100 based on the subject invention comprises a key input 110, a display 115, a communication unit 120, a sound outputting unit 125, and a control unit 130. A portable terminal 100 can, of course, further comprise additional components (e.g., microphone and voice processing unit, in the case of a mobile communication terminal) depending on its function, but these components are not essential to the present invention, and thus will be omitted from the description. A portable terminal 100 can definitely comprise a power unit, but this will also be omitted from the description.

A key input 110 is the means for receiving key selection signals corresponding to the function setting data and call command (e.g., selection of a phone number or call button) on a receiver from the user.

A key input 110 comprises an image sensor 140, A/D converter 145, and key selection recognizer 150.

The image sensor 140 consists of a plurality of unit cells in a lattice shape (Refer to FIG. 2), delivering electric signals corresponding to the amount of irradiated light to the A/D converter 145.

In general, an image sensor refers to an apparatus forming an image on an arrangement of MOS transistor or CCD memory to convert to an electrical signal.

For example, a unit cell (unit pixel) of a CMOS image sensor consists of a photodiode (PD) and 4 NMOS transistors (i.e., transfer transistor (Tx), reset transistor (Rx), drive transistor (Dx), and select transistor (Sx)). A unit cell uses a native transistor to sense the light of visible ray wavelength band in a photodiode (PD) region and accumulates the photogenerated charge, which is transported to a floating diffusion (FD) region to, in effect, output the photogenerated charge, delivered to the gate of Dx, as an electrical signal through Vout.

The A/D converter 145 converts analog electrical signals, received from the image sensor 140, to digital output signals and sends to the key selection recognizer 150.

The key selection recognizer 150 uses output signals outputted from the unit cells of lattice type and converted to digital signals to determine which key areas are selected, and delivers the corresponding key button information to the control unit 130. The key selection recognizer can analyze the image captured by the image sensor 140 to identify the selected key area. This can be done because the area on which an image is captured is displayed dark if the size of the output signal of a certain unit cell is reduced.

In other words, the key selection recognizer 150 can either recognize that a key area corresponding to one or more unit cells showing the smallest (or relatively small) value is selected among the output signals outputted sequentially from each unit cell or use the output signal of each unit cell to recognize that a key area corresponding to the darkest (or relatively dark) area is selected in the generated image. Although the description will be limited to the first method hereinafter, those of ordinary skill in the art shall be able to easily embody the second method.

Although unillustrated, the key input 110 can further comprise a separate power unit to turn on the power on a portable terminal 100. This is because the image sensor 140 and key selection recognizer 150 may not operate while the power is off on the portable terminal 100. The power button can be located on one side or the back of the portable terminal 100.

Although a power button is not prepared on the key input 110, the power-on command can be automatically recognized when the battery, which was separated from the portable terminal 100, is installed on the portable terminal 100.

FIG. 2 illustrates how a key input 110 is realized. Although FIG. 2 shows an embodiment of the present invention in a mobile communication terminal, the key input 110 of this invention is not limited to the type of portable terminal 100 and can be applied in an identical or similar manner.

As shown in FIG. 2, the keypad area 110 of a mobile communication terminal is a solid plate in order to protect the image sensor 140 underneath. The solid plate is transparent (e.g., glass or acryl) with an appropriate thickness, in order for the light to pass through the solid plate to reach the image sensor 140.

As shown with 210, the surface of the solid plate can be printed with an arrangement of key buttons that are similar to the keypad pattern of a typical portable terminal or can be adhered with a transparent sticker, on which a key button arrangement is printed. Furthermore, the key area corresponding to each key button is set to correspond to one or more unit cells of the image sensor 140 located underneath,

That is, when the user places a finger in a key area, the unit cells corresponding to the key area will get relatively smaller amount of light irradiated, and as a result outputs an output signal of a smaller size. The key selection recognizer 150 compares the values of output signals inputted sequentially from the unit cells of the image sensor 140 (or analyzes the image captured by the image sensor 140) to determine which key area the placement of the user's finger corresponds, and recognizes the key button the user selected.

Each unit cell is equipped with a control switch (to turn off the operation of the unit cell) that can be controlled externally, and the key selection recognizer 150 can receive the output signal of each unit cell sequentially by controlling the switch equipped in each unit cell. The method of recognizing the selected key button by the key selection recognizer 150 will be described later in detail with reference to a relative drawing.

Referring back to FIG. 1, the display 115 displays through the control of the control unit 130 the operation status and current time, corresponding to the user's key selection using the key input 110. The display 115 can be an LCD, for example.

The communication unit 120 carries out the function of receiving a voice signal from a mobile communication service system, or transmitting a voice signal to a mobile communication service system. In case the user tries to use a wireless Internet service, it receives the corresponding data from a mobile communication service system. Of course, the communication unit 120 can be a plurality, depending on the usage.

The sound outputting unit 125 serves the means for outputting the received voice signals or ring tones for incoming calls.

The control unit 130 controls the key input 110, display 115, communication unit 120, and sound outputting unit 125 for the control of a portable terminal 100.

Although not illustrated in FIG. 1, a portable terminal 100 can additionally comprise a storage for storing the operation program, communication-related data (e.g., electronic serial number of the terminal, phone number, etc.) for communication service, user information (e.g., phone number, short message communication data, etc.), data between unit cells and key areas, and temporary data during the key button recognition by the key selection recognizer 150. Moreover, the storage can comprise a plurality of memories, depending on the type of data stored.

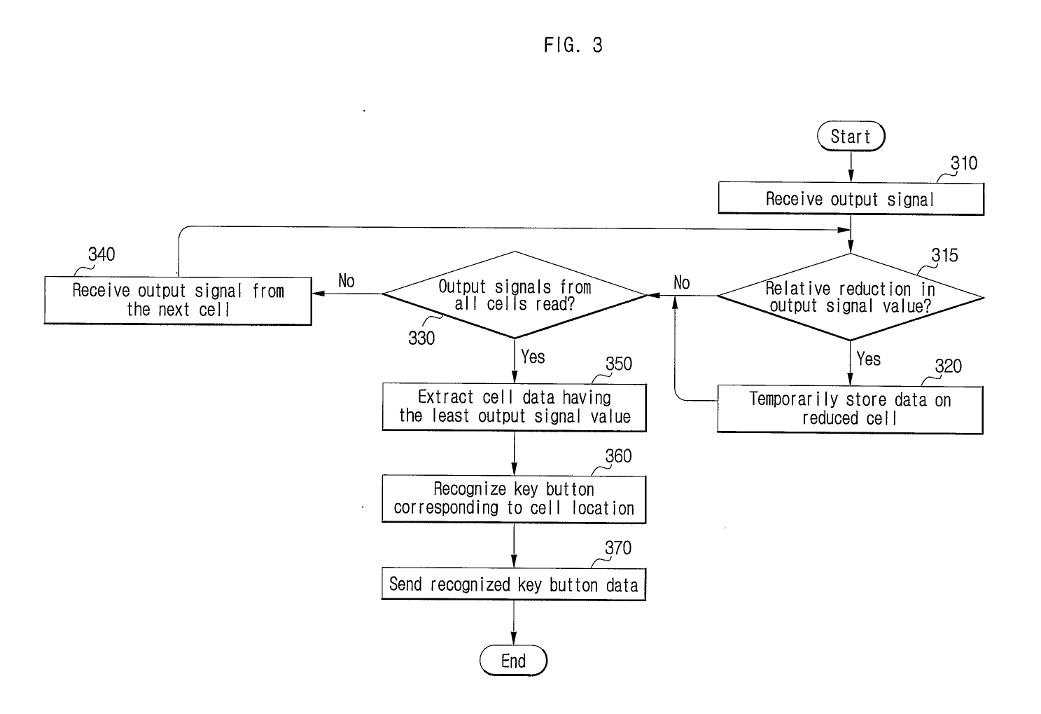

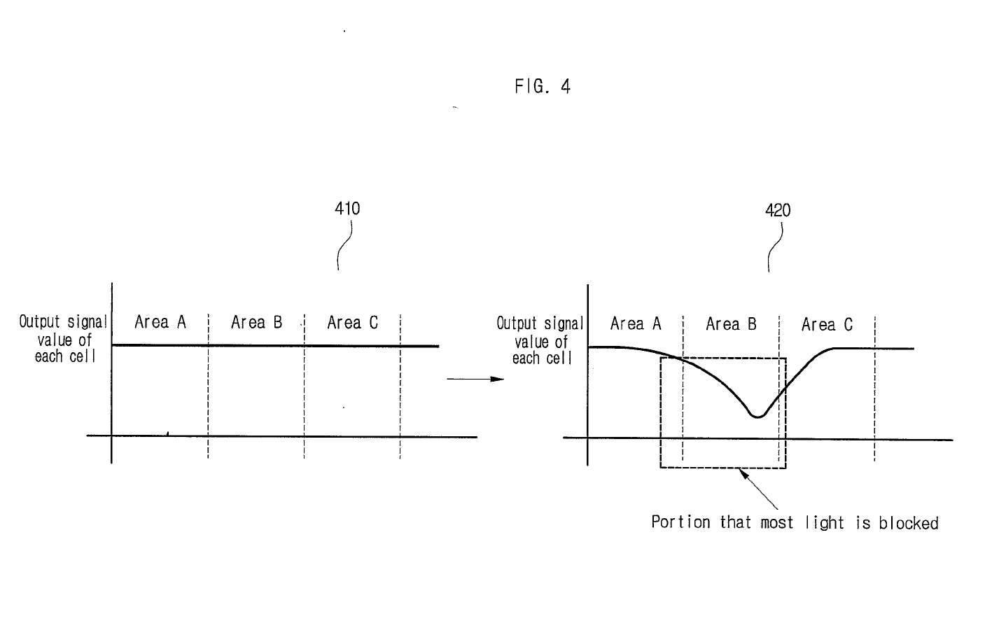

FIG. 3 is a flowchart of the method for key button recognition, selected by the key button selection recognizer, based on a preferred embodiment of this invention, and FIG. 4 is a graph illustrating the change in output signal value, based on a preferred embodiment of this invention.

Referring to FIG. 3, the key selection recognizer 150 receives an output signal, in step 310, from a unit cell in the image sensor 140 underneath the solid plate 210 (Refer to FIG. 2) equipped in the key input 110 of the portable terminal 100. As described earlier, the output signal inputted into the key selection recognizer 150 becomes converted to a digital signal by the A/D converter 145. Also, as described earlier, the digital signals converted by the A/D converter 145 can form a picked-up image.

Step 310 is carried out when the user instructs the portable terminal 100 to operate (e.g., when the user flips the folder-type portable phone open), and steps between 310 and 370 can be repeated at predetermined intervals.

In step 315, the key selection recognizer 150 determines if the value of an inputted output signal became relatively smaller than the value of a previously inputted output signal from another unit cell. Relative reduction in the value of output signal from a unit cell means a relatively smaller amount of light irradiated to the photodiode of the unit cell. It also means that an object is present in a key area corresponding to the unit cell in the plurality of key button images printed on the solid plate. Relative reduction in the value of output signal can also be determined by the brightness of a generated image.

If the value of the current output signal inputted from a unit cell is relatively smaller, the data on the reduced cell (e.g., location, output signal value, corresponding key, etc.) are temporarily stored in a storage in step 320, and step 330 is carried out. If, however, the value of the output signal currently inputted from a unit cell is not relatively smaller, step 330 is immediately carried out.

In step 330, the key selection recognizer 150 determines if output signals from all unit cells included in the image sensor 140 are read. The key selection recognizer 150 controls a control switch corresponding to (or operating in relation with) each unit cell not only to sequentially receive the output signal from each unit cell but also to determine by which unit cell the output signal is currently received. If output signals from all unit cells are not read, step 340 is carried out to control the control switch corresponding to the next unit cell and receive the output signal. If, however, output signals from all unit cells are read, step 350 is carried out.

In step 350, the key selection recognizer 150 extracts the data on a cell having the least output signal value, using at least one cell data stored in the storage. Of course, as described earlier, one or more areas that are the darkest (or relatively dark) can be selected from the generated image, using output signals of all cells. FIG. 4 shows a graph illustrating the change in output signal value, depending on the presence of an object on the solid plate. As shown in 410 of FIG. 4, the output signal value corresponding to each key area is identical to each other, in case no object is place on the solid plate. This is because each unit cell is receiving the same amount of light. As shown in 420, however, if an object is present on a key area (e.g., Area B), the output signal value of the unit cell corresponding to the key area is relatively smaller than the output signal values of unit cells corresponding to other key areas. Thus, the location of the object can be recognized if the unit cell having the least output signal value can be recognized, and in effect to which key button the object is corresponding among the key buttons printed on the solid plate can be recognized.

The key selection recognizer 150 recognizes, in step 360, a key button on which the user's finger is placed, using the cell data having the least output signal value, and in step 370 sends the recognized key button data to the control unit 130. In step 360, the methods for recognizing a key button can include reading the relevant data if a key button data corresponding to a cell data stored through step 320 is included and identifying a key area corresponding to the relevant location data if only the location data is included in the relevant cell data.

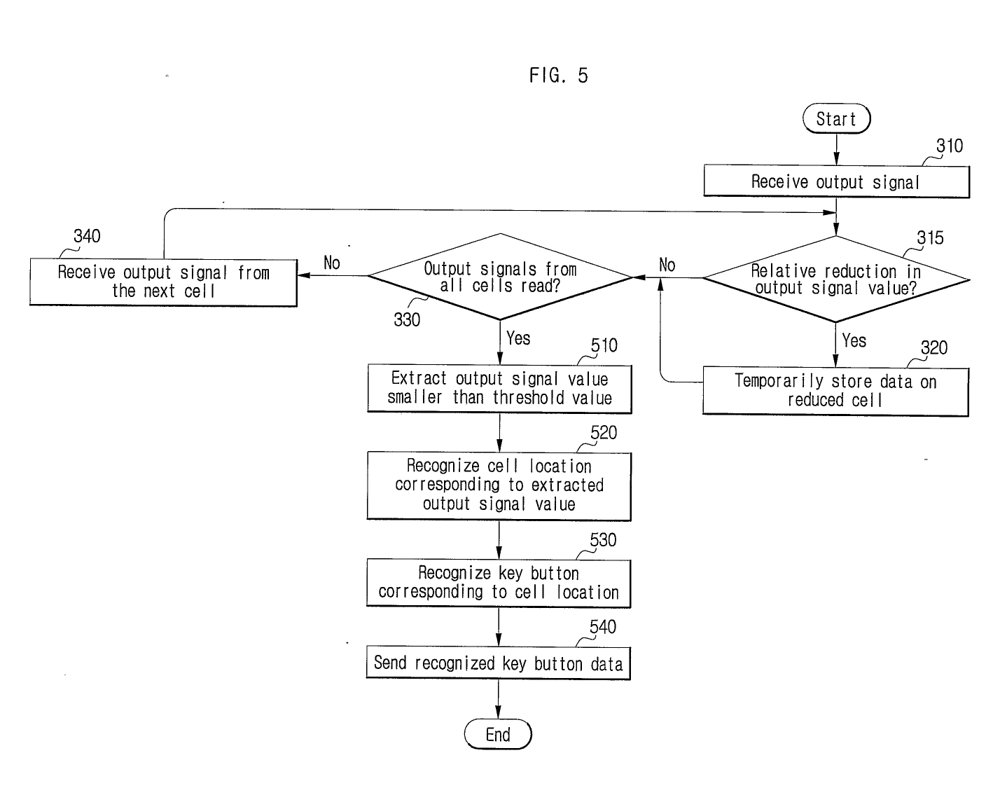

FIG. 5 is a flowchart of the method for recognizing a key button by the key selection recognizer, based on another embodiment of the present invention.

Referring to FIG. 5, the key selection recognizer 150 receives an output signal, in step 310, from a unit cell in the image sensor 140 underneath the solid plate 210 equipped in the key input 110 of the portable terminal 100. Step 310 is carried out when the user instructs the portable terminal 100 to operate (e.g., when the user flips the folder-type portable phone open), and steps between 310 and 540 can be repeated at predetermined intervals.

In step 315, the key selection recognizer 150 determines if the value of an inputted output signal became relatively smaller than the value of a previously inputted output signal from another unit cell.

If the value of the current output signal inputted from a unit cell is relatively smaller, the data on the reduced cell (e.g., location, output signal value, corresponding key, etc.) are temporarily stored in a storage in step 320, and step 330 is carried out. If, however, the value of the output signal currently inputted from a unit cell is not relatively smaller, step 330 is immediately carried out.

In step 330, the key selection recognizer 150 determines if output signals from all unit cells included in the image sensor 140 are read. If output signals from all unit cells are not read, step 340 is carried out to control the control switch corresponding to the next unit cell and receive the output signal. If, however, output signals from all unit cells are read, step 510 is carried out.

In step 510, the key selection recognizer 150 extracts an output signal value that is smaller than a predetermined threshold value, using at least one cell data stored in the storage. This is to prevent any erroneous operation by objects other than human fingers, by considering that a key button is not pressed if an output signal value is smaller than the threshold value. For setting the key button to be operable by operation tools, such as a stylus, the output signal value when a key button is selected using the operation tool can be set as the threshold value.

If an output signal value smaller than the predetermined threshold value is extracted, the key selection recognizer 150 recognizes the location of a unit cell corresponding to the extracted output signal value in step 520, and step 530 is carried out to recognize a key button corresponding to the cell location. As described earlier, steps 520 and 530 can be combined in one step if a key button data corresponding to the cell data stored through step 320 is included. Thereafter, the key selection recognizer 150 sends the recognized key button data to the control unit 130.

A portable terminal 100 may have to select a plurality of key buttons simultaneously, for example the shift key+“a.” The key button recognition method, illustrated in FIG. 5, based on the present invention, extracts all output signal values that are smaller than the threshold value and have the corresponding key button data sent to the control unit 130, such that all key button data for a plurality of key buttons that the user selected can be sent to the control unit 130, and the corresponding operations are possible.

Of course, portable terminals 100, such as mobile communication terminals, that are conventionally manufactured and marketed, are operated by sequentially selecting a key button at a time. Hence, the key selection recognizer 150 may treat a simultaneous selection of a plurality of key buttons by a user as an error. In this case, if the key selection recognizer 150 extracts, in step 510, an output signal value having the least value, and determines whether the extracted output signal value is smaller than the threshold value, occurrence of error or erroneous operation can be minimized.

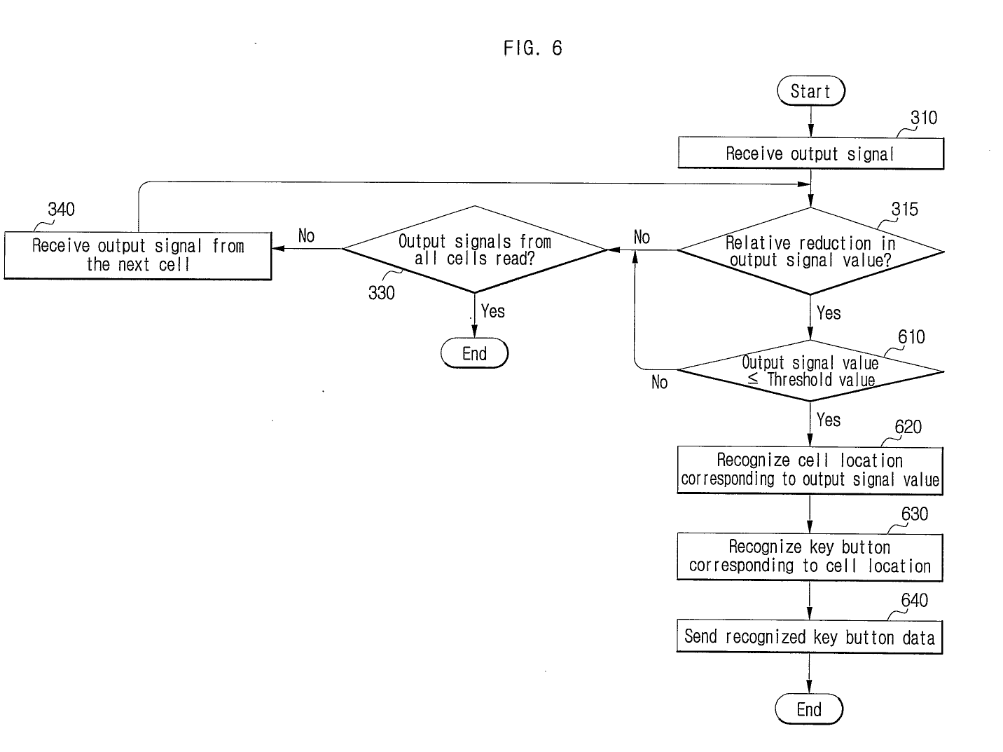

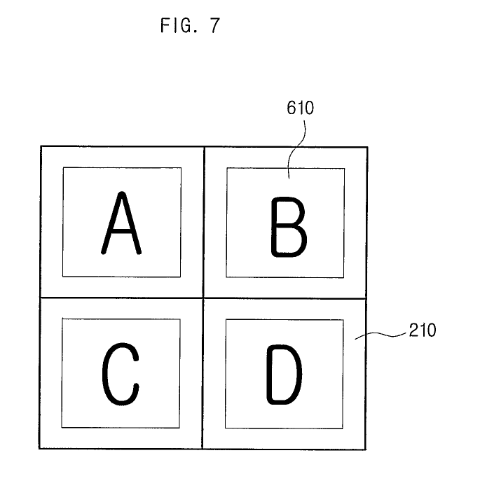

FIG. 6 is a flowchart of the method for recognizing a key button by the key selection recognizer, based on yet another embodiment of the present invention.

Referring to FIG. 6, the key selection recognizer 150 receives an output signal, in step 310, from a unit cell in the image sensor 140 underneath the solid plate 210 equipped in the key input 110 of the portable terminal 100. Step 310 is carried out when the user instructs the portable terminal 100 to operate (e.g., when the user flips the folder-type portable phone open), and steps between 310 and 640 can be repeated at predetermined intervals.

In step 315, the key selection recognizer 150 determines if the value of an inputted output signal became relatively smaller than the value of a previously inputted output signal from another unit cell.

If the value of the current output signal inputted from a unit cell became relatively smaller, step 610 is carried out, and the key selection recognizer 150 determines whether the inputted output signal value is smaller than the predetermined threshold value.

If the output signal value is smaller than the threshold value, the key selection recognizer 150 recognizes the cell location, in step 620, corresponding to the current inputted output signal value, and step 630 is carried out to recognize a key button corresponding to the recognized cell location. Thereafter, the key selection recognizer 150 sends the recognized key button data to the control unit 130.

If, however, the value of the output signal currently inputted from a unit cell did not become relatively smaller, step 330 is immediately carried out.

In step 330, the key selection recognizer 150 determines if output signals from all unit cells included in the image sensor 140 are read. If output signals from all unit cells are not read, step 340 is carried out to control the control switch corresponding to the next unit cell and receive the output signal. If, however, output signals from all unit cells are read, the process is stopped.

FIG. 7 is an illustration of a key input based on another preferred embodiment of the present invention.

Earlier, a key input 110 using an image sensor was described with reference to FIGS. 1 through 6. The key input 110 based on this invention can be realized using a photo sensor 610, not an image sensor, as shown in FIG. 7. That is, a photo sensor 610 corresponding to each key button image printed on the solid plate 210 is placed underneath the solid plate 210, and the key selection recognizer 150 receives an output signal outputted from each photo sensor 610, corresponding to the location of the user's finger, to recognize the key button the user selected. When the key input 110 is realized with a photo sensor 610 instead of an image sensor, only the external appearance is different while the process of operation is very similar to the above description, which will be hence omitted.

The accompanying drawings and detailed description are only an example of the present invention, serve only for describing the present invention, and by no means limit or restrict the spirit and scope of the present invention. Thus, any person of ordinary skill in the art shall understand that a large number of permutations and other embodiments are possible. The true scope of the present invention must be defined only by the spirit of the appended claims.

### INDUSTRIAL APPLICABILITY

As described above, the portable terminal having inputting means using an image sensor and its input method, based on the present invention, realizes the key input of a portable terminal using an image sensor, eliminating the need to design the size of key button to fit the size of human fingers and enabling portable terminals to be designed smaller.

Moreover, the present invention allows a normal operation by the key button the user intended although a plurality of key buttons are recognized to have been pressed by the user's finger due to the compact size of key buttons.

Furthermore, the present invention can solve the problem of key button malfunctions due to a variety of causes (e.g., foreign objects inserted between key buttons) from extended use of the portable terminal.

What is claimed is:

1. An image sensing device for use in a keypad area of a portable terminal, the image sensing device comprising:
a transparent plate, said transparent plate being configured to be disposed within the keypad area of the portable terminal;
an image sensor, said image sensor having lattice type unit cells, the image sensor outputting an electrical signal in response to a irradiated state with light through said transparent plate; and
a key selection recognizer, said key selection recognizer generating a key button selection signal corresponding to the location of a unit cell that outputted the least electrical signal value.

2. The image sensing device of claim 1, wherein
said transparent plate has a plurality of keys and said each key is disposed above at least one corresponding unit cell.

3. The image sensing device of claim 1 further comprising an A/D converter converting an analog electrical signal outputted from said unit cell to a digital electrical signal and delivering to said key selection recognizer.

4. The image sensing device of claim 1, wherein said key selection recognizer turns each unit cell on/off individually.

5. The image sensing device of claim 1, wherein said key selection recognizer determines if the value of said minimum electrical signal is smaller than a predetermined critical value and generates said key button selection signal only if said value of said minimum electrical signal is smaller than said critical value.

6. A recording medium recording a program organizing commands that are executable by a portable terminal (wherein said portable terminal has a transparent solid plate in a keypad area and comprises an image sensor having unit cells of lattice type outputting an electrical signal corresponding to the light irradiated through said transparent solid plate, and a keypad image, on which a plurality of key buttons are arranged, is printed on one side of said transparent solid plate, or a transparent sticker, on which said keypad image is printed, is adhered to one side of said transparent solid plate, and each key button included in said keypad image is corresponded to at least one unit cell), for executing a method for recognizing a key button selected by a user, comprising the acts of:
(a) receiving an input of electrical signal from at least one unit cell;
(b) determining whether the value of said electrical signal became smaller than the value of the immediately previous inputted electrical signal;
(c) recognizing, if it became smaller, a key button corresponding to a unit cell that outputted said electrical signal; and
(d) generating and outputting a key button selection signal corresponding to said recognized key button.

7. The recording medium of claim 6, wherein the program further receives an electrical signal input outputted by activating a unit cell of the latter sequence if the value of said electrical signal did not become smaller than the value of the immediately previous inputted electrical signal.

8. The recording medium of claim 6, wherein the steps of recognizing a key button corresponding to a unit cell that outputted said electrical signal comprise:
(a) determining whether the value of said electrical signal is smaller than a predetermined critical value, if the value of said electrical signal became smaller than the value of the immediately previous inputted electrical signal; and
recognizing, if it is smaller than a predetermined critical value, a key button corresponding to the location of a unit cell that outputted said electrical signal.

9. A method of inputting data using a keypad combined with a lattice type image sensor for a portable terminal, the method comprising the steps of:
(a) receiving an inputted electrical signal from at least one unit cell of said lattice type image sensor;
(b) determining whether the value of said electrical signal is smaller than the value of the immediately previous inputted electrical signal;
(c) recognizing, if it is smaller, a key corresponding to a unit cell that outputted said electrical signal; and
(d) generating a key button selection signal corresponding to said recognized key.

10. The method of claim 9 further comprising the step of: receiving an electrical signal input outputted by activating a unit cell of the latter sequence if the value of said electrical signal is not smaller than the value of the immediately previous inputted electrical signal.

11. The method of claim 9, wherein the step (c) comprises:
(c1) determining whether the value of said electrical signal is smaller than a predetermined critical value, if the value of said electrical signal became smaller than the value of the immediately previous inputted electrical signal; and
(c2) recognizing, if it is smaller than a predetermined critical value, a key corresponding to the location of a unit cell that outputted said electrical signal.

12. An image sensing device for use in a keypad area of a portable terminal, the image sensing device comprising:
a transparent plate, said transparent plate being configured to be disposed within the keypad area of the portable terminal;
an image sensor, said image sensor having lattice type unit cells, the image sensor outputting an electrical signal in response to a irradiated state with light through said transparent plate; and
means for generating a key selection signal corresponding to the location of a unit cell that outputted the least electrical signal value.

13. The image sensing device of claim 12, wherein said transparent plate has a plurality of keys and said each key is disposed above at least one corresponding unit cell.

14. The image sensing device of claim 12, wherein said means for generating a key selection signal turns each unit cell on/off individually.

15. The image sensing device of claim 12, wherein said means for generating a key selection signal determines if the value of said minimum electrical signal is smaller than a predetermined critical value and generates said key button selection signal only if said value of said minimum electrical signal is smaller than said critical value.

16. An image sensing device for use in a keypad area of a portable terminal, the image sensing device comprising:
a keypad, said keypad having a plurality of keys, the keypad being configured to be transparent sufficient to allow light to pass said keypad;
an image sensor, said image sensor having lattice type unit cells, the image sensor outputting an electrical signal in response to a irradiated state with light through said keypad; and
means for generating a key selection signal corresponding to the location of a unit cell that outputted the least electrical signal value.

17. The image sensing device of claim 16, wherein said each key is disposed above at least one corresponding unit cell.

18. The image sensing device of claim 16, wherein said means for generating a key selection signal turns each unit cell on/off individually.

19. The image sensing device of claim 16, wherein said means for generating a key selection signal determines if the value of said minimum electrical signal is smaller than a predetermined critical value and generates said key button selection signal only if said value of said minimum electrical signal is smaller than said critical value.
